(19) United States
(12) Patent Application Publication
(10) Pub. No.: US 2024/0145754 A1
(43) Pub. Date: May 2, 2024

(54) BATTERY MODULE MANUFACTURING DEVICE AND BATTERY MODULE MANUFACTURING METHOD

(71) Applicant: BOE Technology Group Co., Ltd., Beijing (CN)

(72) Inventors: Lu WU, Beijing (CN); Sitong CHEN, Beijing (CN); Yue CUI, Beijing (CN); Hong ZHU, Beijing (CN)

(21) Appl. No.: 18/272,133

(22) PCT Filed: Oct. 22, 2021
(86) PCT No.: PCT/CN2021/125848

§ 371 Date: Jul. 13, 2023

(30) Foreign Application Priority Data
Mar. 31, 2021 (CN) 202110349585.8

(51) Int. Cl. H01M 10/04; H01M 50/204

(52) U.S. Cl. CPC H01M 10/0404; H01M 50/204

(57) ABSTRACT

Provided are a battery module manufacturing device and a battery module manufacturing method. The battery module manufacturing device includes a cell hot pressing assembly, and the cell hot pressing assembly includes a first hot pressing part and a second hot pressing part which are oppositely disposed; the first hot pressing part includes at least one upper pressing head, and the side of each upper pressing head facing the second hot pressing part is provided with a piston inner pressing head; the second hot pressing part includes at least one lower pressing head in one-to-one correspondence to the upper pressing head, the side of each lower pressing head facing the first hot pressing part is provided with two parallel side baffles, a limiting gap is formed between the two side baffles.

### CROSS REFERENCE TO RELATED APPLICATIONS

The present application claims priority to the Chinese patent application No. 202110349585.8 filed on Mar. 31, 2021 to the China Patent Office, and entitled “BATTERY MODULE MANUFACTURING DEVICE AND BATTERY MODULE MANUFACTURING METHOD”, the entire content of which is incorporated herein by reference.

### TECHNICAL FIELD

The present application relates to the technical field of batteries, in particular to a battery module manufacturing device and a battery module manufacturing method.

### BACKGROUND

With people's discontinuous increasing demands for smart devices and electronic products, flexible/wearable electronic devices, implantable/repairable biomedical systems, electric vehicles and a series of products are widely applied, stimulating the relentless pursuit of people for high performance batteries with high energy density, shape diversity, deformation diversity, and good mechanical properties.

A bamboo-shaped battery is an implementation solution for implementing a flexible battery, and includes a plurality of rigid energy storage units for connecting through flexible connecting components. The rigid energy storage units may be compatible with the structure, material and process of a traditional rigid lithium-ion battery. The flexible connecting components may be selected from a diaphragm and a package material in a lithium-ion battery body structure or be implemented by introducing new flexible connecting materials such as a flexible printed circuit board and a flexible composite layer. The capacity of the bamboo-shaped battery is closely related to the number and volume of its rigid energy storage units, and generally speaking, the larger the volume of the rigid energy storage units, the more active materials, and the higher the capacity. However, the volume of the rigid energy storage units is increased, resulting in increased widths, and affecting an ultimate bending radius, and thus, thicknesses and widths of the rigid energy storage units and intervals of the adjacent rigid energy storage units need to be accurately controlled.

### SUMMARY

The present application provides a battery module manufacturing device and a battery module manufacturing method, the above battery module manufacturing device enables the volume capacity density of cells to be improved, and sizes of the cells and intervals of the adjacent cells are accurately controlled.

In order to achieve the above objectives, the present application provides the following technical solution.

A battery module manufacturing device, a battery module includes a plurality of cells, and each cell includes a cell body, and a positive lug and a negative lug located at two ends of the cell body; the battery module manufacturing device includes a cell hot pressing assembly, and the cell hot pressing assembly includes a first hot pressing part and a second hot pressing part which are oppositely disposed.

The first hot pressing part includes at least one upper pressing head, and a side of each upper pressing head facing the second hot pressing part has a piston inner pressing head.

The second hot pressing part includes at least one lower pressing head in one-to-one correspondence to the upper pressing head, a side of each lower pressing head facing the first hot pressing part is provided with two parallel side baffles, a limiting gap is formed between the two parallel side baffles, the limiting gap is configured to limit a size of the cell body in an extension direction perpendicular to the cell body, and the limiting gap is opposite to the piston inner pressing head.

The first hot pressing part has an initial station and a hot pressing station.

When the first hot pressing part is located at the initial station, the piston inner pressing heads, the lower pressing heads and the two side baffles are matched to encircle an accommodating cavity for placing a to-be-hot pressed cell body; and when the first hot pressing part is located at the hot pressing station, the piston inner pressing heads may be inserted into the limiting gap between the two side baffles to perform hot pressing on the to-be-hot pressed cell body.

In the battery module manufacturing device provided by the embodiments of the present application, the cell hot pressing assembly is included, in a hot pressing process of the cell hot pressing assembly for the cells in the accommodating cavity, first, the upper pressing heads move facing the lower pressing heads, and the piston inner pressing heads of the upper pressing heads are inserted into the limiting gaps between the two side baffles to perform hot pressing on the cells; and then, after the cells are hot pressed for a preset time at a preset position, the upper pressing heads move back to an initial position. The cells in the accommodating cavity are firstly pressed flatly under the action of pressure, then are fixed and formed through a hot action, since in the process of the piston inner pressing heads pressing down the cells, side faces of the cells are in contact with side walls of the two side baffles, the upper, lower, left and right of the cells are all extruded, the cells will fill four corners of the accommodating cavity, and a quadrate-like roll cell structure with four chamfers being circular is formed. The above battery module manufacturing device enables the volume capacity density of the cells to be improved, the sizes of the cells may be accurately controlled, especially for small-size cells, more advantages are achieved, high-throughput hot pressing integrating of the cells may be achieved, the integrating efficiency and consistency of the cells are improved, sizes of the intervals of the adjacent cells may be accurately arranged when battery modules are assembled, and accurate control over ultimate bending radiuses of first flexible connecting parts and second flexible connecting parts is ensured.

Optionally, a supporting mechanism is further included, and the supporting mechanism includes a base, a pressing head bracket and supporting columns; the base is located on one sides of the lower pressing heads facing away from the first hot pressing part for supporting the lower pressing heads; the pressing head bracket is located on one sides of the upper pressing heads facing away from the second hot pressing part for driving the upper pressing heads to move; and the supporting columns are located on the base, and penetrate through the upper pressing heads and the lower pressing heads, and the upper pressing heads may move on the supporting columns.

Optionally, the accommodating cavity internally has a limiting column to limit moving positions of the piston inner pressing heads facing the lower pressing heads.

Optionally, a short circuit detection mechanism, a first contact and a second contact are further included.

The first contact is configured to be connected with the positive lugs of the cells located in the accommodating cavity; the second contact is configured to be connected with the negative lugs of the cells located in the accommodating cavity; and the short circuit detection mechanism is connected between the first contact and the second contact.

Optionally, heating units in one-to-one correspondence to the upper pressing heads are further included, and each heating unit is separately controllable.

Optionally, materials of the piston inner pressing heads, side walls of the two side baffles and the lower pressing heads include rigid metal materials.

Optionally, a cell assembling assembly is further included, and the cell assembling assembly includes a cell placing mold and two fixed jigs located on two sides of the cell placing mold respectively; the cell placing mold includes a plurality of placing grooves, the plurality of placing grooves are arranged in a first direction, and each placing groove is configured to place a cell body; and the two fixed jigs are arranged on two sides of the cell placing mold in the first direction, each fixed jig includes a middle area corresponding to the cell placing mold and a first end area and a second end area located on two sides of the middle area, the two first end areas are configured to limit a first flexible connecting part of the battery module, the two second end areas are configured to limit a second flexible connecting part of the battery module, in the battery module, the positive lugs of at least two cells are electrically connected with a positive connecting end through the first flexible connecting part, and the negative lugs of at least two cells are electrically connected with a negative connecting end through the second flexible connecting part.

Optionally, widths of the first end areas and the second end areas in an arrangement direction of the placing grooves are smaller than widths of the middle areas in an arrangement direction of the placing grooves.

Optionally, a battery module housing stamping assembly is further included, and the battery module housing stamping assembly includes a base station, a lower mold portion and an upper mold portion; the lower mold portion is located on the base station, a side of the lower mold portion facing away from the base station has a first press fit area of a first flexible sealing part for placing a battery module housing, and the first press fit area includes a plurality of stamping grooves; the upper mold portion is located on a side of the lower mold portion facing away from the base station, the upper mold portion includes a second press fit area corresponding to the first press fit area, and the second press fit area is provided with a protrusion part; the upper mold portion has a free station and a stamping station; when the upper mold portion is located at the free station, the upper mold portion is not in press fit with the lower mold portion; and when the upper mold portion is located at the stamping station, a protrusion of the upper mold portion is in alignment press fit with the first press fit area of the lower mold portion, so that the first flexible sealing part forms plastic package grooves in one-to-one correspondence to the stamping grooves, and the plastic package grooves are configured to place the cell bodies of the cells of the battery module.

Optionally, an edge of the protrusion has a chamfer structure, and an edge of each stamping groove has a chamfer structure.

Optionally, the lower mold portion is provided with at least one guiding column, the upper mold portion is provided with guiding holes corresponding to the guiding columns, and in a process of the upper mold portion moving to the lower mold portion, the guiding columns and the guiding holes may be matched for guiding.

An embodiment of the present application further provides a battery module manufacturing method, applying any one of the battery module manufacturing devices provided in the above technical solution, including: manufacturing to-be-hot pressed cells; moving a first hot pressing part of the battery module manufacturing device to an initial station, and placing the to-be-hot pressed cells into an accommodating cavity of a cell hot pressing assembly; and controlling the first hot pressing part to move to a hot pressing station until the to-be-hot pressed cells are close to two side baffles forming the accommodating cavity in an extension direction perpendicular to the cells, to form hot pressed shaped cells.

Optionally, when the battery module manufacturing device includes a cell assembling assembly, after forming the hot pressed shaped cells, the manufacturing method further includes: placing the cell bodies of the plurality of hot pressed shaped cells into placing grooves of a cell placing mold, wherein positive lugs and negative lugs of the cells are located on an outer side the cell placing mold, the positive lugs are located on one sides where first end areas of fixed jigs are located, and the negative lugs are located on one sides where second end areas of the fixed jigs are located; arranging first flexible connecting parts on the two fixed jigs through two first end areas, and arranging second flexible connecting parts on the two fixed jigs through two second end areas; connecting the positive lugs of the at least two hot pressed shaped cells with the first flexible connecting parts, and connecting the negative lugs of the at least two hot pressed shaped cells with the second flexible connecting parts; connecting one ends of the first flexible connecting parts with positive connecting ends, and connecting one ends of the second flexible connecting parts with negative connecting ends; clipping two sides of the first flexible connecting parts and two sides of the second flexible connecting parts; and folding the first flexible connecting parts and the second flexible connecting parts to be connected with the same sides of the cell bodies to form a battery body.

Optionally, when the battery module manufacturing device includes a battery module housing stamping assembly, after forming the battery body, the manufacturing method further includes: placing the battery body, a first flexible sealing part and a second flexible sealing part into a first press fit area of a lower mold portion, wherein the battery body is located between the first flexible sealing part and the second flexible sealing part, and the second flexible sealing part is located on one side of the first flexible sealing part facing away from the lower mold portion; and performing alignment press fit on a protrusion of an upper mold portion and a first press fit area of the lower mold portion, so as to make the first flexible sealing part in sealing fit with the second flexible sealing part mutually to package the battery body.

Optionally, after the first flexible sealing part hermetically matches with the second flexible sealing part mutually, the method further includes: performing battery liquid injection, battery formation, air pocket clipping and battery capacity grading processes in sequence on the packaged battery body to form a battery module.

### BRIEF DESCRIPTION OF FIGURES

FIG. 1 is a schematic structural diagram of a battery module provided by an embodiment of the present application.

FIG. 2A is a schematic diagram of a film layer of a cell provided by an embodiment of the present application.

FIG. 2B is a schematic diagram of a film layer of another cell provided by an embodiment of the present application.

FIG. 3 is a schematic structural diagram of a cell provided by an embodiment of the present application.

FIG. 4 is a schematic structural diagram of a hot pressing apparatus in the related art.

FIG. 5 is a cell formed by an existing hot pressing apparatus.

FIG. 6 is a schematic structural diagram of a cell hot pressing assembly provided by an embodiment of the present application.

FIG. 7A is a state diagram of a cell hot pressing assembly provided by an embodiment of the present application.

FIG. 7B is a state diagram of another cell hot pressing assembly provided by an embodiment of the present application.

FIG. 7C is a state diagram of another cell hot pressing assembly provided by an embodiment of the present application.

FIG. 8 is a schematic structural diagram of a cell provided by an embodiment of the present application.

FIG. 9 is a schematic structural diagram of a short circuit detection mechanism provided by an embodiment of the present application.

FIG. 10 is a schematic structural diagram of a cell hot pressing assembly provided by an embodiment of the present application.

FIG. 11A is a schematic structural diagram of a cell assembling assembly provided by an embodiment of the present application.

FIG. 11B is a schematic structural diagram of another cell assembling assembly provided by an embodiment of the present application.

FIG. 12A is a state diagram of assembling a battery module provided by an embodiment of the present application.

FIG. 12B is a state diagram of assembling a battery module provided by an embodiment of the present application.

FIG. 13 is a schematic structural diagram of a battery module provided by an embodiment of the present application.

FIG. 14 is a schematic structural diagram of another battery module provided by an embodiment of the present application.

FIG. 15 is a schematic structural diagram of a battery module housing stamping assembly provided by an embodiment of the present application.

FIG. 16 is a flow diagram of a battery module manufacturing method provided by an embodiment of the present application.

FIG. 17 is a flow diagram of another battery module manufacturing method provided by an embodiment of the present application.

FIG. 18 is a flow diagram of another battery module manufacturing method provided by an embodiment of the present application.

### REFERENCE NUMERALS

1—battery body; 11—cell; 111—cell body; 1111—first diaphragm; 1112—negative plate; 1113—second diaphragm; 1114—positive plate; 112—positive lug; 113—negative lug; 12—first flexible connecting part; 13—second flexible connecting part; 14—positive connecting end; 15—negative connecting end; 16—lug adhesive; 2—flexible packaging housing; 21—first flexible sealing part; 211—plastic package groove; 22—second flexible sealing part; 31—first hot pressing part; 311—upper pressing head; 312—piston inner pressing head; 32—second hot pressing part; 321—lower pressing head; 322—side baffle; 331—base; 332—pressing head bracket; 333—supporting column; 341—first contact; 342—second contact; 35—heating unit; A—accommodating cavity; 41—cell placing mold; 411—placing groove; 42—fixed jig; 421—middle area; 422—first end area; 423—second end area; 51—base station; 52—lower mold portion; 521—stamping groove; 522—guiding column; and 53—upper mold portion.

### DETAILED DESCRIPTION

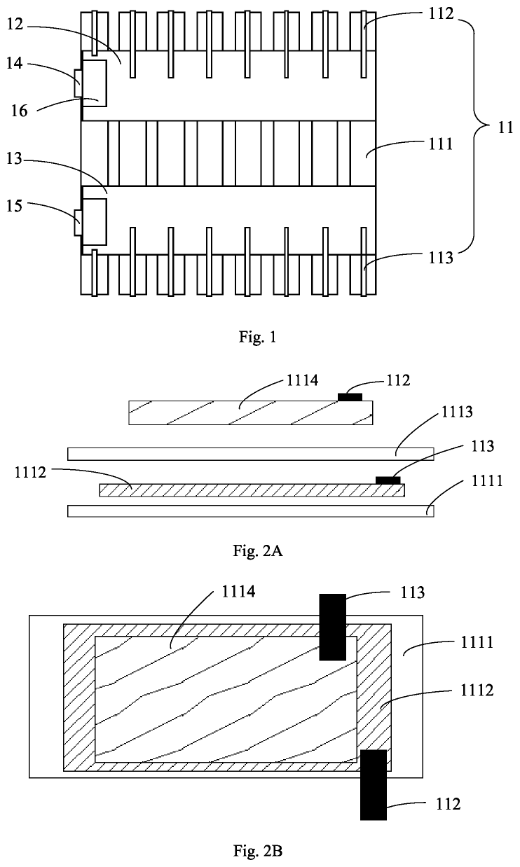

In related art, as shown in FIG. 1, a bamboo-shaped flexible battery module includes a plurality of cells 11, first flexible connecting parts 12, second flexible connecting parts 13, positive connecting ends 14 and negative connecting ends 15. Each cell 11 includes a cell body 111 and a positive lug 112 and a negative lug 113 located at two ends of the cell body 111, the plurality of cell bodies 111 are sequentially arranged in a first direction, and a preset gap is provided between two adjacent cells 11. The first flexible connecting parts 12 and the second flexible connecting parts 13 are used for connecting the plurality of cell bodies 111, the positive connecting ends 14 and the negative connecting ends 15 are arranged at end parts of the first flexible connecting parts 12 and the second flexible connecting parts 13 respectively, the positive lugs 112 of the cell bodies 111 are electrically connected with the positive connecting ends 14 through the first flexible connecting parts 12, and the negative lugs 113 of the cell bodies 111 are electrically connected with the negative connecting ends 15 through the second flexible connecting parts 13.

The above cells 11 may be of a lithium battery structure. The first flexible connecting parts 12 and the second flexible connecting parts 13 may be conductive flexible connecting materials, such as a flexible printed circuit board, which is not limited here, and is determined according to actual conditions. The positive connecting ends 14 and the negative connecting ends 15 may be wrapped with lug adhesives 16.

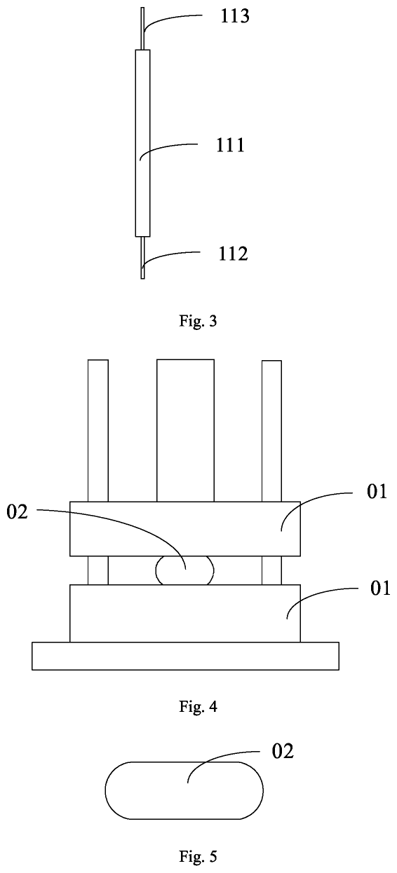

In a specific implementation, as shown in FIG. 2A and FIG. 2B, the above cells 11 are provided with first diaphragms 1111, negative plates 1112, second diaphragms 1113, positive plates 1114 which are sequentially stacked, and negative lugs 113 arranged on the negative plates 1112 and positive lugs 112 arranged on the positive plates 1114, in order to increase the capacity of the cells 11, the positive plates, the negative plates and the diaphragms of the cells 11 are wound to form an energy storage unit, as shown in FIG. 3.

As for the above bamboo-shaped flexible battery module, in order to adapt to a related application scene, the battery module is required to have a certain bending radius and corresponding capacity, for example, the battery module may be applied to flexible products needed to be bent, folded and even in a twisted form, such as a flexible bracelet, crimp display and bending display. An ultimate bending radius of the above battery module depends on the bending capacity of the first flexible connecting parts and the second flexible connecting parts, which is closely related to widths of the cells and intervals of the adjacent cells. The capacity of the battery module is closely related to the number of the cells and the volumes of the cells, and generally speaking, the larger the volumes of the cells, the more active materials, and the higher the capacity. However, the volumes of the cells are increased, resulting in increased widths and affecting the ultimate bending radius, and thus, thicknesses and widths of the cells and intervals of the adjacent cells need to be accurately controlled.

At present, when lithium ion batteries are deigned, positive plates, negative plates and diaphragms of the batteries are generally wound to form an energy storage unit to increase the capacity of the lithium ion batteries. In a practical production process, an energy storage unit of lithium ion batteries manufactured by adopting a winding process is generally internally fluffy, a conventional hot pressing process needs to be introduced generally, the batteries wound with a certain number of circles are shaped, the energy storage unit of the batteries is compact, meanwhile, an interface contact between the plates and the diaphragms is improved, internal resistance of the batteries is reduced, the ionic conductivity is improved, and then the capacity utilization efficiency is improved. Therefore, in the above battery module, hot pressing shaping needs to be performed on the cells when the cells are manufactured.

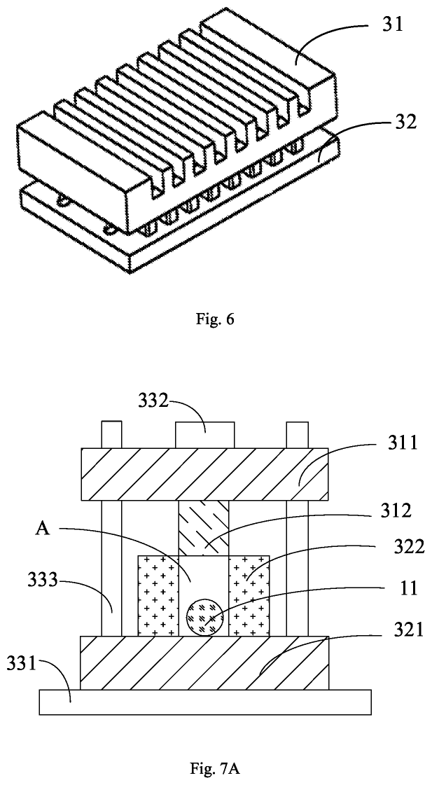

At present, as shown in FIG. 4, conventional hot pressing refers to using two upper and lower heating plates 01 to perform hot pressing on the cell 02 with a constant pressure and temperature, a combined action of hot and pressure enables diaphragms coated with adhesive layers to be bonded to positive and negative electrode plates to form a good interface contact, and meanwhile, a shape of the cell is controlled. However, as shown in FIG. 5, a proportion of a width/thickness of the cell 02 after conventional hot pressing shaping is larger, and a width direction is not limited, resulting in that the size cannot be accurately controlled. Special porosities of two end face areas of the cell 02 after conventional hot pressing shaping in a width direction are larger, the total volume is larger, and the same volume capacity density is reduced; and the porosity of the cell 02 after conventional hot pressing shaping in a thickness direction cannot be controlled, hot pressing dead angle areas may appear, the ionic conductivity is reduced, and capacity exerting is affected.

In order to solve the problems of poor control over the sizes of the cells and the intervals of the adjacent cells in the battery module, an embodiment of the present application provides a battery module manufacturing device.

Specific implementations of the battery module manufacturing device provided by the embodiment of the present application are illustrated in detail in conjunction with accompanying drawings below. Thicknesses and shapes of structures in the accompanying drawings do not reflect a true scale, and are merely intended to illustrate contents of the present application.

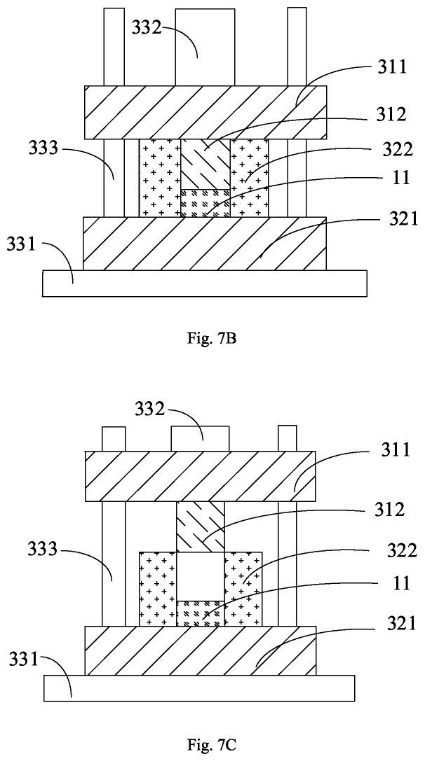

As shown in FIG. 6, FIG. 7A, FIG. 7B and FIG. 7C, the battery module manufacturing device provided by the embodiments of the present application may include a cell hot pressing assembly, and the cell hot pressing assembly includes a first hot pressing part 31 and a second hot pressing part 32 which are oppositely disposed.

The first hot pressing part 31 may include at least one upper pressing head 311, and a side of each upper pressing head 311 facing the second hot pressing part 32 is provided with a piston inner pressing head 312.

The second hot pressing part 32 may include at least one lower pressing head 321 in one-to-one correspondence to the upper pressing heads 311, a side of each lower pressing head 321 facing the first hot pressing part 31 is provided with two parallel side baffles 322, a limiting gap is formed between the two parallel side baffles 322, the limiting gap is configured to limit sizes of cell bodies 111 in an extension direction perpendicular to the cell bodies 111, and the limiting gap is opposite to the piston inner pressing heads 312.

Specifically, the first hot pressing part 31 is provided with an initial station and a hot pressing station.

When the first hot pressing part 31 is located at the initial station, the piston inner pressing heads 312, the lower pressing heads 321 and the two side baffles 322 are matched to encircle an accommodating cavity A for placing a to-be-hot pressed cell body 111, as shown in FIG. 7A.

When the first hot pressing part is located at the hot pressing station, the piston inner pressing heads 312 may be inserted into the limiting gap between the two side baffles 322 to perform hot pressing on the to-be-hot pressed cell body 111, as shown in FIG. 7B.

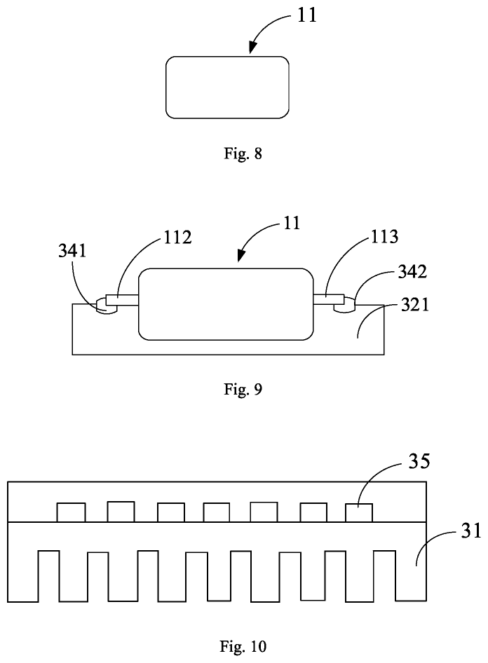

In the battery module manufacturing device provided by the embodiments of the present application, the cell hot pressing assembly is included, in the process of the cell hot pressing assembly performing hot pressing on the cells 11 located in the accommodating cavity A, first, as shown in FIG. 7B, the upper pressing heads 311 move facing the lower pressing heads 321, and the piston inner pressing heads 312 on the upper pressing heads 311 are inserted into the limiting gap between the two side baffles 322 to perform hot pressing on the cells 11; and then, as shown in FIG. 7C, after hot pressing is performed on the cells 11 for a preset time at a preset position, the upper pressing heads 311 move back to an initial position. The cells 11 in the accommodating cavity A are firstly pressed flatly under the action of pressure, then are fixed and formed through a hot action, since in the process of the piston inner pressing heads 312 pressing down the cells 11, side faces of the cells 11 are in contact with side walls of the two side baffles 322, the upper, lower, left and right of the cells 11 are all extruded, the cells 11 will fill four corners of the accommodating cavity A, and a quadrate-like roll cell structure with four chamfers being circular is formed, as shown in FIG. 8. The above battery module manufacturing device enables the volume capacity density of the cells 11 to be improved, the sizes of the cells may be accurately controlled, especially for small-size cells, more advantages are achieved, high-throughput hot pressing integrating of the cells may be achieved, the integrating efficiency and consistency of the cells are improved, sizes of the intervals of the adjacent cells may be accurately arranged when battery module is assembled, and accurate control over ultimate bending radiuses of the first flexible connecting parts and the second flexible connecting parts are ensured.

The battery module manufacturing device provided by the embodiments of the present application is adopted to perform hot pressing shaping on the cells, perform an electric performance test after the cells are assembled into the battery module, and is compared with the performance of the battery module assembled by the cells obtained through conventional hot pressing to obtain the following experimental data. The capacity of the battery module may be designed as 85 mAh, and a width-to-thickness ratio of the cells manufactured by the battery module manufacturing device provided by the embodiment of the present application is designed to be 5.5 mm/3.5 mm. Compared with a width-to-thickness ratio of conventional hot pressing, the width-to-thickness ratio of the cells obtained through hot pressing shaping by the battery module manufacturing device provided by the embodiments of the present application is smaller (being 5.4 mm/3.2 mm and 6 mm/3.2 mm respectively) and is controllable.

Table 1 shows a comparison of a capacity of the cells obtained after conventional hot pressing shaping with that of the cells obtained after hot pressing shaping in the embodiments of the present application. Table 2 shows a comparison of discharging rate performance of the cells obtained after conventional hot pressing shaping with that of the cells obtained after hot pressing shaping in the embodiments of the present application. Contents of Table 1 and Table 2 represent that the cells manufactured through hot pressing shaping in the embodiments of the present application have higher volume capacity density, and the large rate discharging capacity of the cells is better.

TABLE 1

| | Hot pressing mode | | | |
|---|---|---|---|---|
| | | | Hot pressing shaping | |
| | | | in the embodiments of | |
| | Conventional hot pressing | | the present application | |
| | | Volume | | Volume |
| | | capacity | | capacity |
| | Capacity | density | Capacity | density |
| Parameter | mAh | mAh/mm3 | mAh | mAh/mm3 |
| First group | 80.100 mAh | 4.17 | 79.90 mAh | 4.62 |
| Second group | 79.750 mAh | 4.15 | 79.60 mAh | 4.61 |
| Third group | 79.150 mAh | 4.12 | 79.48 mAh | 4.60 |

TABLE 2

| | | Hot pressing shaping |
|---|---|---|
| | Conventional hot | in the embodiments of |
| Hot pressing mode | pressing shaping | the present application |
| 1C DC | 57.975 mAh | 65.950 mAh |
| 1C Rate Efficiency | 72.96% | 82.98% |

In a specific implementation, as shown in FIG. 7A and FIG. 7C, the cell hot pressing assembly further includes a supporting mechanism, and the supporting mechanism may include a base 331, a pressing head bracket 332 and supporting columns 333; the base 331 is located on one sides of the lower pressing heads 321 facing away from the first hot pressing part 31 for supporting the lower pressing heads 321; the pressing head bracket 332 is located on one sides of the upper pressing heads 311 facing away from the second hot pressing part 32 for driving the upper pressing heads 311 to move; and the supporting columns 333 are located on the base 331, and penetrate through the upper pressing heads 311 and the lower pressing heads 321, and the upper pressing heads 311 may move on the supporting columns 333. For example, the supporting columns 333 are arranged on two sides of the two side baffles 322 respectively, the upper pressing heads 311 may move on the supporting columns 333, so that two sides of the upper pressing heads 311 synchronously move, and uniform stress of the cells 11 during hot pressing may be ensured.

In a specific implementation, the accommodating cavity A may be internally provided with a limiting column, so as to limit positions of the piston inner pressing heads 312 moving facing the lower pressing heads 321. The limiting column may accurately control a moving distance of the lower pressing heads 321, and the hot pressing quality and consistency of the cells 11 may be improved.

In a specific implementation, as shown in FIG. 9, the cell hot pressing assembly may further be provided with a short circuit detection mechanism, a first contact 341 and a second contact 342; the first contact 341 and the second contact 342 may be arranged on the lower pressing heads 321, when hot pressing is performed on the cells 11, the first contact 341 may be connected with positive lugs 112 of the cells 11 located in the accommodating cavity A, and the second contact 342 may be connected with negative lugs 113 of the cells 11 located in the accommodating cavity A; and the short circuit detection mechanism is connected between the first contact 341 and the second contact 342, resistances of the cells 11 may be detected through the short circuit detection mechanism, and whether the cells 11 are short circuited may be detected through a resistance value obtained through measurement between the positive lugs 112 and the negative lugs 113 of the cells 11. The above short circuit detection mechanism may conveniently and fast detect the quality of the cells 11 after hot pressing shaping and assess the yield of the hot pressing shaping process, and is contribute to optimizing and improving the hot pressing shaping process through process parameter regulating and controlling modes such as hot pressing temperature, hot pressing pressure, hot pressing time, pressing head moving speed, etc. during hot pressing.

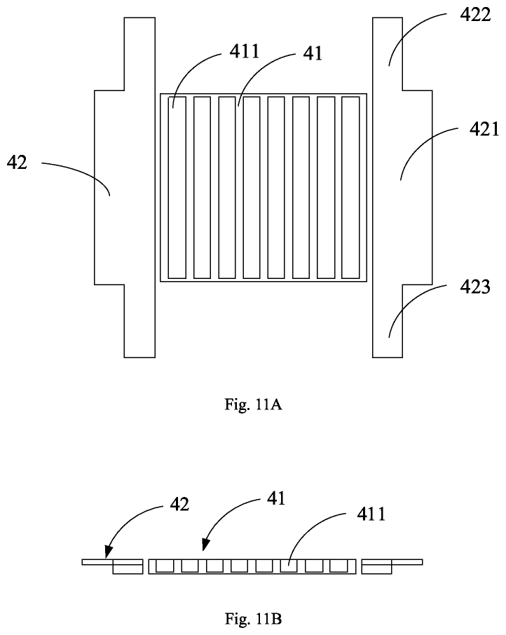

In a specific implementation, as shown in FIG. 10, the plurality of hot pressing heads in the first hot pressing part 31 may be set as an integrated structure, manufacturing is convenient, and the structure is simple.

In a specific implementation, as shown in FIG. 10, the cell hot pressing assembly may further include heating units 35 in one-to-one correspondence to the upper pressing heads 311, each heating unit 35 may heat the piston inner pressing heads 312 of the upper pressing heads 311 corresponding to the heating units, since each heating unit 35 is separately controllable, heating temperature may be distributed more uniformly and accurately, the precision of the shaping hot pressing process may be improved, and the quality of battery roll cells is improved.

In the above embodiment of the present disclosure, materials of the piston inner pressing heads 312, the two side baffles 322 and the lower pressing heads 321 may be rigid metal materials. For example, brass, brass is a rigid material, the cells are not prone to deforming in the hot pressing process by adopting the rigid material, hot pressing roll cells may be ensured to have good thermal conductivity in the hot pressing process by adopting the brass material, which is contribute to improving binding materials in the roll cells and achieving uniform binding and uniform porosity, dead areas are reduced, the quality and yield of the hot pressing shaped battery roll cells are improved, and they may further be other rigid materials, which are not limited herein.

In the battery module manufacturing device provided by the embodiment of the present application, a cell assembling assembly may further be included, as shown in FIG. 11A and FIG. 11B, and the cell assembling assembly may specifically include a cell placing mold 41 and two fixed jigs 42 located on two sides of the cell placing mold 41 respectively; the cell placing mold 41 includes a plurality of placing grooves 411, the plurality of placing grooves 411 are arranged in a first direction, and each placing groove 411 is used for placing a cell 11 body; and the two fixed jigs 42 are arranged on two sides of a cell 11 placing module in the first direction, each fixed jig 42 includes a middle area 421 corresponding to the cell placing mold 41 and a first end area 422 and a second end area 423 located on two sides of the middle area 421, the two first end areas 422 are used for limiting a first flexible connecting part 12 of the battery module, the two second end areas 423 are used for limiting a second flexible connecting part 13 of the battery module, in the battery module, the positive lugs 112 of at least two cells 11 are electrically connected with a positive connecting end 14 through the first flexible connecting part 12, and the negative lugs 113 of at least two cells 11 are electrically connected with a negative connecting end 15 through the second flexible connecting part 13.

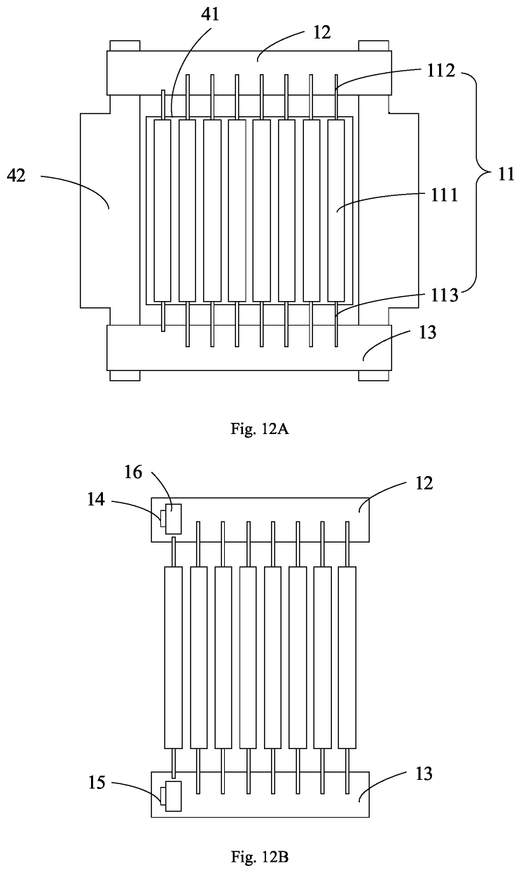

When the battery module is assembled by using the above cell assembling assembly, as shown in FIG. 12A, firstly the plurality of cells 11 after hot pressing shaping may be placed in the cell placing mold 41, the cell bodies 111 may be placed in the placing grooves 411 in a one-to-one correspondence mode, the positive lugs 112 and the negative lugs 113 of the cells 11 are exposed outside the cell placing mold 41, the positive lugs 112 of all the cells 11 and the first end areas 422 of the fixed jigs 42 may be located on the same side, and the negative lugs 113 of all the cells 11 and the second end areas 423 of the fixed jigs 42 may be located on the same side; then the first flexible connecting part 12 may be wound on the two opposite first end areas 422 of the two fixed jigs 42, and the second flexible connecting part 13 are wound on the two opposite second end areas 423 of the two fixed jigs 42; then all the positive lugs 112 are connected with the first flexible connecting part 12, all the negative lugs 113 are connected with the second flexible connecting part 13, as shown in FIG. 12B, the positive connecting end 14 is arranged at one end of the first flexible connecting part 12, and the negative connecting end 15 is arranged at one end of the second flexible connecting part 13; and then sizes of the first flexible connecting part 12 and the second flexible connecting part 13 are clipped, and finally a first flexible unit and a second flexible unit are overturned to be connected with the cell bodies 111 to form a battery body 1. The above cell assembling assembly is simple in structure and convenient to operate, and may save manufacturing cost.

In a specific implementation, as shown in FIG. 11A, widths of the first end areas 422 and the second end areas 423 in an arrangement direction of the placing grooves 411 are smaller than a width of the middle area 421 in an arrangement direction of the placing grooves 411, and winding positions of the first flexible connecting part 12 and the second flexible connecting part 13 may be limited, which is beneficial to connecting of the positive lugs 112 and the negative lugs 113 of the cells 11 with the first flexible connecting part 12 and the second flexible connecting part 13.

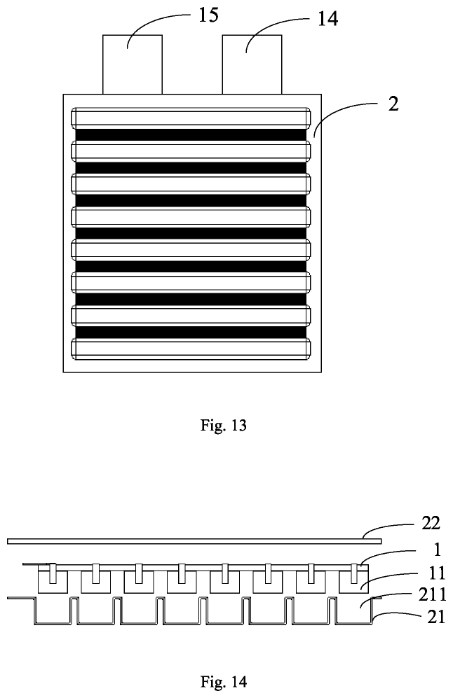

The above battery module further includes a flexible packaging housing 2, as shown in FIG. 13 and FIG. 14, and the flexible packaging housing 2 may include a first flexible sealing part 21 and a second flexible sealing part 22; the first flexible sealing part 21 may be provided with a plurality of plastic package grooves 211 in one-to-one correspondence to the cell bodies 111, the cell bodies 111 may be placed in the plastic package grooves 211 in a one-to-one correspondence mode, and open edges of the two adjacent plastic package grooves 211 are connected, so that a shape of the first flexible sealing part 21 is matched with a shape of the battery body 1; and the second flexible sealing part 22 is located on one side of the battery body 1 facing away from the first flexible sealing part 21, and is in sealing fit with the first flexible sealing part 21, so that the battery body 1 is packaged and protected, and forms such as curling and bending of a flexible battery are achieved. The positive connecting end 14 and the negative connecting end 15 are exposed outside the flexible packaging housing 2, and energy stored in the battery body 1 may be transferred to other devices through the positive connecting end 14 and the negative connecting end 15.

In a specific implementation, the above flexible packaging housing 2 may include thermal sealing layers, metal layers and a protection layer which are sequentially arranged in a thickness direction thereof; the thermal sealing layers are arranged close to the battery body 1, the thermal sealing layers may be set two, and two thermal sealing layers may be closely combined with each other to ensure the packaging strength; the protection layer located outside may be used for preventing battery invalidation caused by external force action; and the metal layers located between the thermal sealing layers and the protection layer may use calendaring-state metal to prevent water and steam from entering the battery.

In the battery module manufacturing device provided by the embodiment of the present application, as shown in FIG. 13, a battery module housing stamping assembly may further be included, and the battery module housing stamping assembly may include a base station 51, a lower mold portion 52 and an upper mold portion 53; the lower mold portion 52 is located on the base station 51, a side of the lower mold portion 52 facing away from the base station 51 has a first press fit area of the first flexible sealing part 21 for placing a battery module housing, and the first press fit area includes a plurality of stamping grooves 521; and the upper mold portion 53 is located on a side of the lower mold portion 52 facing away from the base station 51, the upper mold portion 53 includes a second press fit area corresponding to the first press fit area, and the second press fit area is provided with a protrusion part.

Specifically, the upper mold portion 53 has a free station and a stamping station; when the upper mold portion 53 is located at the free station, the upper mold portion 53 is not in press fit with the lower mold portion 52; and when the upper mold portion 53 is located at the stamping station, a protrusion of the upper mold portion 53 is in alignment press fit with the first press fit area of the lower mold portion 52, so that the first flexible sealing part 21 forms plastic package grooves 211 in one-to-one correspondence to the stamping grooves 521, and the plastic package grooves 211 are used for placing the cell bodies 111 of the cells 11 of the battery module.

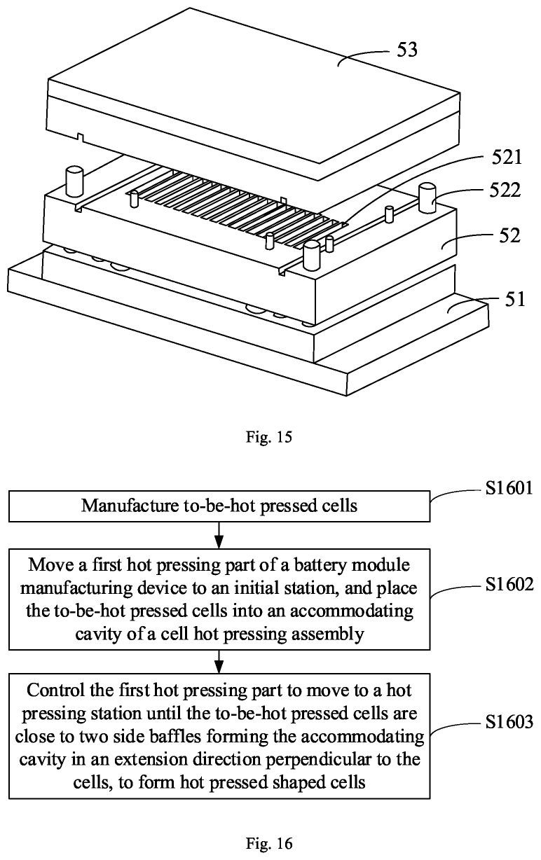

When the above battery module housing stamping assembly is used, first, the battery body 1, the first flexible sealing part 21 and the second plastic package part are placed in the first press fit area of the lower mold portion 52, the battery body 1 is located between the first flexible sealing part 21 and the second flexible sealing part 22, as shown in FIG. 14, the second flexible sealing part 22 is located on one side of the first flexible sealing part 21 facing away from the lower mold portion 52, and the battery body 1 may be in one-to-one correspondence to the stamping grooves 521 in the first press fit area; and then, alignment press fit is performed on the protrusion of the upper mold portion 53 and the first press fit area of the lower mold portion 52, so that the first flexible sealing part 21 is in mutual sealing fit with the second flexible sealing part 22 to package the battery body 1, as shown in FIG. 15. The above battery module housing stamping assembly is simple in structure, and enables the first flexible sealing part 21 and the second flexible sealing part 22 to be sealed, the battery module may be protected, and a life of a battery is prolonged.

Optionally, an edge of the protrusion opposite to the first press fit area has a chamfer structure, and an edge of each stamping groove 521 has a chamfer structure. In the process of stamping the first flexible sealing part 21 and the second flexible sealing part 22, since the chamfer structures are arranged at the edge of the protrusion and the edges of the stamping grooves 521, stamping stress on the first flexible sealing part 21 and the second flexible sealing part 22 may be reduced, package material damage in the stamping process may be relieved, and the manufacturing yield of flexible batteries is improved. Specifically, chamfers may be circular chamfers.

In a specific implementation, the lower mold portion 52 is provided with at least one guiding column 522, the upper mold portion 53 is provided with guiding holes corresponding to the guiding columns 522, and in a process of the upper mold portion 53 moving to the lower mold portion 52, the guiding columns 522 and the guiding holes may be matched for guiding.

Based on the same inventive concept, an embodiment of the present application further provides a battery module manufacturing method, applying any one of the battery module manufacturing devices provided in the technical solution, and as shown in FIG. 16, specifically including the following operations.

S1601: to-be-hot pressed cells are manufactured.

Specifically, firstly positive plates and negative plates are manufactured, positive lugs are welded to the positive plates, negative lugs are welded to the negative plates, the positive lugs and the negative lugs are wrapped with lug adhesives, materials of the positive plates may be lithium cobalt oxides, materials of the negative plates may be graphite, materials of the positive lugs may be aluminum (Al), and materials of the negative lugs may be nickel (Ni); then first diaphragms, the negative plates, second diaphragms and the positive plates are sequentially stacked and put into a stack layer; and finally, the above stack layer is wound into the to-be-hot pressed cells in a winding mode, and the cells are ensured to be closely wrapped during winding.

S1602: a first hot pressing part of the battery module manufacturing device is moved to an initial station, and the to-be-hot pressed cells are placed into an accommodating cavity of a cell hot pressing assembly.

Specifically, the to-be-hot pressed cells are placed on lower pressing heads, and have a certain distance from two side baffles and piston inner pressing heads, and in order to ensure balance stress of the cells in the hot pressing process, putting positions of the to-be-hot pressed cells may be equal to a distance between the two side baffles.

S1603: the first hot pressing part is controlled to move to a hot pressing station, until the to-be-hot pressed cells are close to two side baffles forming the accommodating cavity in an extension direction perpendicular to the cells, to form hot pressed shaped cells.

Specifically, the piston inner pressing heads are inserted into a gap formed by the two side baffles, the cells are hot pressed, and the piston inner pressing heads slidably extrude the cells to a preset position along side walls of the two side baffles and move away after staying for a fixed time to obtain the hot pressed shaped cells.

In the battery module manufacturing method provided by the embodiment of the present application, the cells in the accommodating cavity are first pressed flatly under the action of pressure, then are fixed and shaped through the terminal action, in the process of the pressing down the cells, side faces of the cells are in contact with side walls of the two side baffles, the upper, lower, left and right of the cells are all extruded, the cells will fill four corners of the accommodating cavity, a quadrate-like roll cell structure with four chamfers being circular is formed, the volume capacity density of the cells may be improved, the sizes of the cells may be accurately controlled, especially for small-size cells, more advantages are achieved, high-throughput hot pressing shaping of the cells may be achieved, the shaping efficiency and consistency of the cells are improved, sizes of the intervals of the adjacent cells may be accurately arranged when battery modules are assembled, and accurate control over ultimate bending radiuses of the first flexible connecting parts and the second flexible connecting parts are ensured.

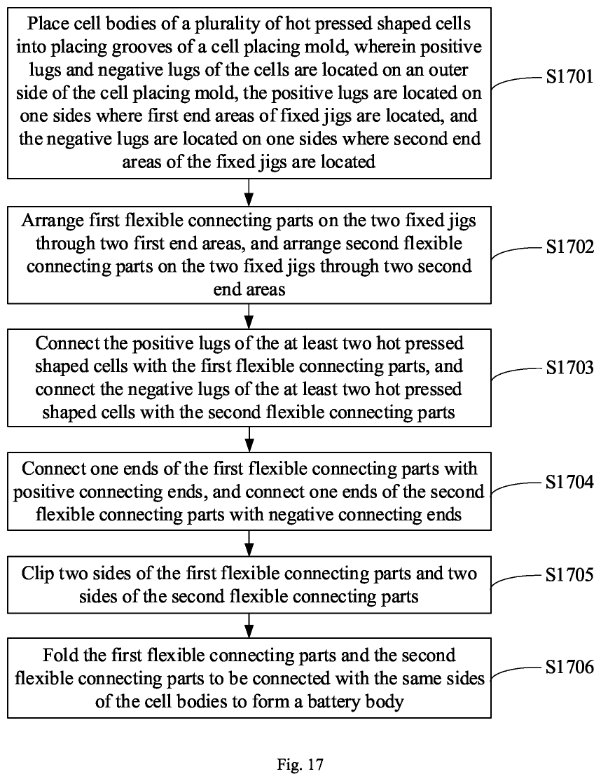

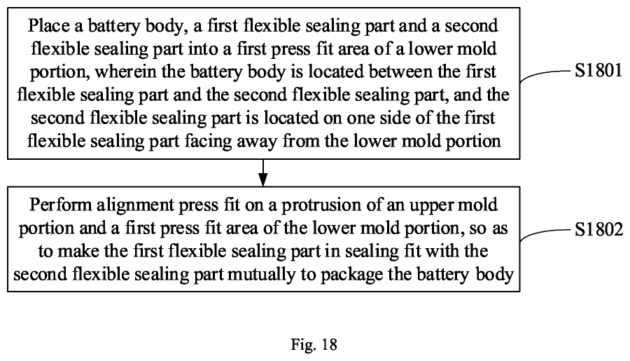

In a specific implementation, when the battery module manufacturing device includes the cell assembling assembly, after forming the hot pressed shaped cells, as shown in FIG. 17, the manufacturing method may further include the following operations.

S1701: the cell bodies of the plurality of hot pressed shaped cells are placed into the placing grooves of the cell placing mold, the positive lugs and the negative lugs of the cells are located on the outer side the cell placing mold, all the positive lugs are located on one sides where first end areas of fixed jigs are located, and all the negative lugs are located on one sides where second end areas of the fixed jigs are located.

S1702: first flexible connecting parts are arranged on the two fixed jigs through two first end areas, and second flexible connecting parts are arrange on the two fixed jigs through two second end areas.

S1703: the positive lugs of the at least two hot pressed shaped cells are connected with the first flexible connecting parts, and the negative lugs of the at least two hot pressed shaped cells are connected with the second flexible connecting parts.

Specifically, in order to ensure that a contact resistance between the lugs and the flexible connecting parts is smaller, an ultrasonic welding mode may be adopted to connect the positive lugs with the first flexible connecting parts and the negative lugs with the second flexible connecting parts.

S1704: one ends of the first flexible connecting parts are connected with positive connecting ends, and one ends of the second flexible connecting parts are connected with negative connecting ends.

Specifically, the ultrasonic welding mode may be adopted to connect the positive connecting ends with the first flexible connecting parts and the negative connecting ends with the second flexible connecting parts, and the positive connecting ends and the negative connecting ends are wrapped with lug adhesives. When the positive connecting ends and the negative connecting ends are connected with the first flexible connecting parts and the second flexible connecting parts respectively, in order to reserve mounting positions for the positive connecting ends and the negative connecting ends, the positive lugs and the negative lugs of the cells may be needed to be clipped.

S1705: two sides of the first flexible connecting parts and two sides of the second flexible connecting parts are clipped.

Specifically, the first flexible connecting parts and the second flexible connecting parts are clipped to obtain the first flexible connecting parts and the second flexible connecting parts with appropriate sizes.

S1706: the first flexible connecting parts and the second flexible connecting parts are folded to be connected with the same sides of the cell bodies to form a battery body.

In a specific implementation, when the battery module manufacturing device includes the battery module housing stamping assembly, after forming the battery body, as shown in FIG. 18, the manufacturing method further includes the following operations.

S1801: the battery body, the first flexible sealing part and the second flexible sealing part are placed into a first press fit area of a lower mold portion, the battery body is located between the first flexible sealing part and the second flexible sealing part, and the second flexible sealing part is located on one side of the first flexible sealing part facing away from the lower mold portion.

Specifically, cell bodies may be in one-to-one correspondence to stamping grooves in the first press fit area.

S1802: alignment press fit is performed on a protrusion of an upper mold portion and a first press fit area of the lower mold portion, so as to make the first flexible sealing part hermetically match with the second flexible sealing part mutually to package the battery body.

Optionally, after the first flexible sealing part is mutually in sealing fit with the second flexible sealing part, the manufacturing method specifically includes: battery liquid injection, battery formation, air pocket clipping and battery capacity grading processes are sequentially performed on the packaged battery body to form a battery module.

Apparently, those skilled in the art may perform various changes and modifications on the embodiments of the present application without departing from the spirit and scope of the embodiments of the present application. In this way, if these changes and modifications on the embodiments of the present application fall in the scope of the claims of the present application and their equivalent technologies, the present application is intended to include these changes and modification.

1. A battery module manufacturing device, a battery module comprising a plurality of cells, and each cell comprising a cell body and a positive lug and a negative lug which are located at two ends of the cell body, wherein the battery module manufacturing device comprises a cell hot pressing assembly, and the cell hot pressing assembly comprises a first hot pressing part and a second hot pressing part which are oppositely disposed;
the first hot pressing part comprises at least one upper pressing head, and a side of each upper pressing head facing the second hot pressing part is provided with a piston inner pressing head;
the second hot pressing part comprises at least one lower pressing head in one-to-one correspondence to the upper pressing head, a side of each lower pressing head facing the first hot pressing part is provided with two parallel side baffles, a limiting gap is formed between the two parallel side baffles, the limiting gap is configured to limit a size of the cell body in an extension direction perpendicular to the cell body, and the limiting gap is opposite to the piston inner pressing head;
the first hot pressing part has an initial station and a hot pressing station;
when the first hot pressing part is located at the initial station, the piston inner pressing heads, the lower pressing heads and the two side baffles are matched to encircle an accommodating cavity for placing to-be-hot pressed cell bodies; and
when the first hot pressing part is located at the hot pressing station, the piston inner pressing heads are able to be inserted into the limiting gap between the two side baffles to perform hot pressing on the to-be-hot pressed cell bodies.

2. The battery module manufacturing device according to claim 1, further comprising a supporting mechanism, wherein the supporting mechanism comprises a base, a pressing head bracket and supporting columns;
the base is located on one sides of the lower pressing heads facing away from the first hot pressing part for supporting the lower pressing heads;
the pressing head bracket is located on one sides of the upper pressing heads facing away from the second hot pressing part for driving the upper pressing heads to move; and
the supporting columns are located on the base, and penetrate through the upper pressing heads and the lower pressing heads, and the upper pressing heads are able to move on the supporting columns.

3. The battery module manufacturing device according to claim 1, wherein the accommodating cavity internally has a limiting column to limit moving positions of the piston inner pressing heads facing the lower pressing heads.

4. The battery module manufacturing device according to claim 1, further comprising a short circuit detection mechanism, a first contact and a second contact;
the first contact being configured to be connected with the positive lug of the cell located in the accommodating cavity;
the second contact being configured to be connected with the negative lug of the cell located in the accommodating cavity; and
the short circuit detection mechanism being connected between the first contact and the second contact.

5. The battery module manufacturing device according to claim 1, further comprising heating units in one-to-one correspondence to the upper pressing heads, and each heating unit being separately controllable.

6. The battery module manufacturing device according to claim 1, wherein materials of the piston inner pressing heads, side walls of the two side baffles and the lower pressing heads comprise rigid metal materials.

7. The battery module manufacturing device according to claim 1, further comprising a cell assembling assembly, and the cell assembling assembly comprising a cell placing mold and two fixed jigs located on two sides of the cell placing mold respectively; wherein
the cell placing mold comprises a plurality of placing grooves, the plurality of placing grooves are arranged in a first direction, and each placing groove is configured to place a cell body; and
the two fixed jigs are arranged on two sides of the cell placing mold in the first direction, each fixed jig comprises a middle area corresponding to the cell placing mold and a first end area and a second end area located on two sides of the middle area, the two first end areas are used for limiting a first flexible connecting part of the battery module, the two second end areas are used for limiting a second flexible connecting part of the battery module; in the battery module, the positive lugs of at least two cells are electrically connected with a positive connecting end through the first flexible connecting part, and the negative lugs of at least two cells are electrically connected with a negative connecting end through the second flexible connecting part.

8. The battery module manufacturing device according to claim 7, wherein widths of the first end areas and the second end areas in an arrangement direction of the placing grooves are smaller than widths of the middle areas in an arrangement direction of the placing grooves.

9. The battery module manufacturing device according to claim 1, further comprising a battery module housing stamping assembly, and the battery module housing stamping assembly comprising a base station, a lower mold portion and an upper mold portion, wherein
the lower mold portion is located on the base station, a side of the lower mold portion facing away from the base station has a first press fit area of a first flexible sealing part for placing a battery module housing, and the first press fit area comprises a plurality of stamping grooves;
the upper mold portion is located on a side of the lower mold portion facing away from the base station, the upper mold portion comprises a second press fit area corresponding to the first press fit area, and the second press fit area is provided with a protrusion part; the upper mold portion has a free station and a stamping station;
when the upper mold portion is located at the free station, the upper mold portion is not in press fit with the lower mold portion; and
when the upper mold portion is located at the stamping station, a protrusion of the upper mold portion is in alignment press fit with the first press fit area of the lower mold portion, so that the first flexible sealing part forms plastic package grooves in one-to-one correspondence to the stamping grooves, and the plastic package grooves are configured to place the cell bodies of the cells of the battery module.

10. The battery module manufacturing device according to claim 9, wherein an edge of the protrusion has a chamfer structure, and an edge of each stamping groove has a chamfer structure.

11. The battery module manufacturing device according to claim 9, wherein the lower mold portion is provided with at least one guiding column, the upper mold portion is provided with guiding holes corresponding to the guiding columns, and in a process of the upper mold portion moving to the lower mold portion, the guiding columns and the guiding holes are able to be matched for guiding.

12. A battery module manufacturing method, applying the battery module manufacturing device according to claim 1, comprising:
manufacturing to-be-hot pressed cells;
moving the first hot pressing part of the battery module manufacturing device to the initial station, and placing the to-be-hot pressed cells into the accommodating cavity of the cell hot pressing assembly; and
controlling the first hot pressing part to move to the hot pressing station until the to-be-hot pressed cells are close to two side baffles forming the accommodating cavity in the extension direction perpendicular to the cells, to form hot pressed shaped cells.

13. The manufacturing method according to claim 12, wherein when the battery module manufacturing device comprises a cell assembling assembly, after forming the hot pressed shaped cells, the manufacturing method further comprises:
placing cell bodies of the plurality of hot pressed shaped cells into placing grooves of a cell placing mold, wherein positive lugs and negative lugs of the cells are located on an outer side the cell placing mold, all the positive lugs are located on one sides where first end areas of fixed jigs are located, and all the negative lugs are located on one sides where second end areas of the fixed jigs are located;
arranging first flexible connecting parts on the two fixed jigs through two first end areas, and arranging second flexible connecting parts on the two fixed jigs through two second end areas;
connecting the positive lugs of the at least two hot pressed shaped cells with the first flexible connecting parts, and connecting the negative lugs of the at least two hot pressed shaped cells with the second flexible connecting parts;
connecting one ends of the first flexible connecting parts with positive connecting ends, and connecting one ends of the second flexible connecting parts with negative connecting ends;
clipping two sides of the first flexible connecting parts and two sides of the second flexible connecting parts; and
folding the first flexible connecting parts and the second flexible connecting parts to be connected with the same sides of the cell bodies to form a battery body.

14. The manufacturing method according to claim 13, wherein when the battery module manufacturing device comprises a battery module housing stamping assembly, after forming the battery body, the manufacturing method further comprises:
placing the battery body, a first flexible sealing part and a second flexible sealing part into a first press fit area of a lower mold portion, wherein the battery body is located between the first flexible sealing part and the second flexible sealing part, and the second flexible sealing part is located on one side of the first flexible sealing part facing away from the lower mold portion; and
performing alignment press fit on a protrusion of an upper mold portion and a first press fit area of the lower mold portion, so as to make the first flexible sealing part in sealing fit with the second flexible sealing part mutually to package the battery body.

15. The manufacturing method according to claim 14, wherein after the first flexible sealing part is in sealing fit with the second flexible sealing part mutually, the method further comprises:
performing battery liquid injection, battery formation, air pocket clipping and battery capacity grading processes in sequence on the packaged battery body to form a battery module.
